(19) United States
(12) Patent Application Publication
(10) Pub. No.: US 2014/0258924 A1
(43) Pub. Date: Sep. 11, 2014

(54) DISPLAY APPARATUS AND DISPLAY METHOD FOR DISPLAYING MAIN DATA AND DATA RELATED TO THAT MAIN DATA, AND A MEMORY MEDIUM

(71) Applicant: Casio Computer Co., Ltd., Tokyo (JP)

(72) Inventor: Shigeo SEKINO, Tokyo (JP)

(73) Assignee: Casio Computer Co., Ltd., Tokyo (JP)

(21) Appl. No.: 14/199,869

(22) Filed: Mar. 6, 2014

(30) Foreign Application Priority Data
Mar. 8, 2013 (JP) 2013-046385

(51) Int. Cl. G06F 3/0484

(52) U.S. Cl. CPC G06F 3/04845
USPC 715/800; 715/788

(57) ABSTRACT

A substitution area is kept in part of a display area of main data while that main data is displayed, and substitutes related data that is related to the main data for the main data, and displays related data in the substitution area. While related data is displayed in the substitution area, the size of the substitution area is increased or decreased in response to an instruction from a user. The user can change the size of the substitution area in real-time as necessary.

### CROSS-REFERENCE TO RELATED APPLICATION

This application claims the benefit of Japanese Patent Application No. 2013-046385, filed on Mar. 8, 2013, the entire disclosure of which is incorporated by reference herein.

### FIELD

This application relates to display technology for displaying information content for main data and related data that is related to the main data.

### BACKGROUND

Conventionally, when displaying information content for main data such as a document, image and the like, displaying information content for related data (hereinafter referred to as related information) that is related to the main data can generally be displayed on that information content (document, image and the like) as necessary. Moreover, for example, Unexamined Japanese Patent Application Kokai Publication No. H7-64979 discloses technology in which, when displaying a document, comment information that is related information for that document, is displayed using an arbitrary size at an arbitrary location on the displayed document.

### SUMMARY

The display apparatus according to a first aspect of the present invention is a display apparatus comprising:

a display section that displays main data and related data that is related to the main data;

a display control section that, when main data is displayed on a screen of the display section, keeps a substitution area, in which other display content is substituted for the displayed content, in part of a display area displaying the main data, and displays the related data substituted for the main data in the substitution area; and

an area control section that changes the position or size of the substitution area kept by the display control section in response to an instruction from a user.

The display method according to a second aspect of the present invention is a display method comprising:

a step that, when main data is displayed on a screen of the display section that displays main data and related data that is related to the main data, keeps a substitution area, in which other display content is substituted for the displayed content, in part of a display area displaying the main data, and displays the related data substituted for the main data in the substitution area; and

a step that changes the position or size of the substitution area in response to an instruction from a user.

The memory medium according to a third aspect of the present invention is a memory medium that can be read by a computer and that stores programs for causing a computer to realize:

a display control function that, when main data is displayed on a screen of be display section that displays main data and related data that is related to the main data, keeps a substitution area, in which other display content is substituted for the displayed content, in part of a display area displaying the main data, and displays the related data substituted for the main data in the substitution area; and

an area control function that changes the position or size of the substitution area kept by the display control function in response to an instruction from a user.

The above and further objects and novel features of the present invention will more fully appear from the following detailed description when the same is read in conjunction with the accompanying drawings. It is to be expressly understood; however, that the drawings are for the purpose of illustration only and are not intended as a definition of the limits of the invention.

### BRIEF DESCRIPTION OF THE DRAWINGS

A more complete understanding of this application can be obtained when the following detailed description is considered in conjunction with the following drawings, in which:

FIG. 1 is a block diagram illustrating a display apparatus of an embodiment of the present invention;

FIG. 2A is a conceptual diagram of a setting table, and FIG. 2B is a drawing for explaining a display graph;

FIG. 3 is a flowchart illustrating a content display process;

FIG. 4 is a flowchart illustrating an added information display process;

FIGS. 5A and 5B are conceptual diagrams that conveniently display an example of the stored state of added data in a main memory;

FIGS. 6A and 6B are drawings illustrating display screens of states in which icons are overlaid over content;

FIGS. 7A and 7B are drawings illustrating display screens when displaying added information in a fixed state;

FIG. 8A is a drawing illustrating a display screen when displaying added information in a shaped state, and FIGS. 8B and 8C are drawings illustrating the transition of the display screen when enlarging or reducing the size of the display of added information; and

FIGS. 9A, 9B and 9C are drawings illustrating variations of the embodiment.

### DETAILED DESCRIPTION

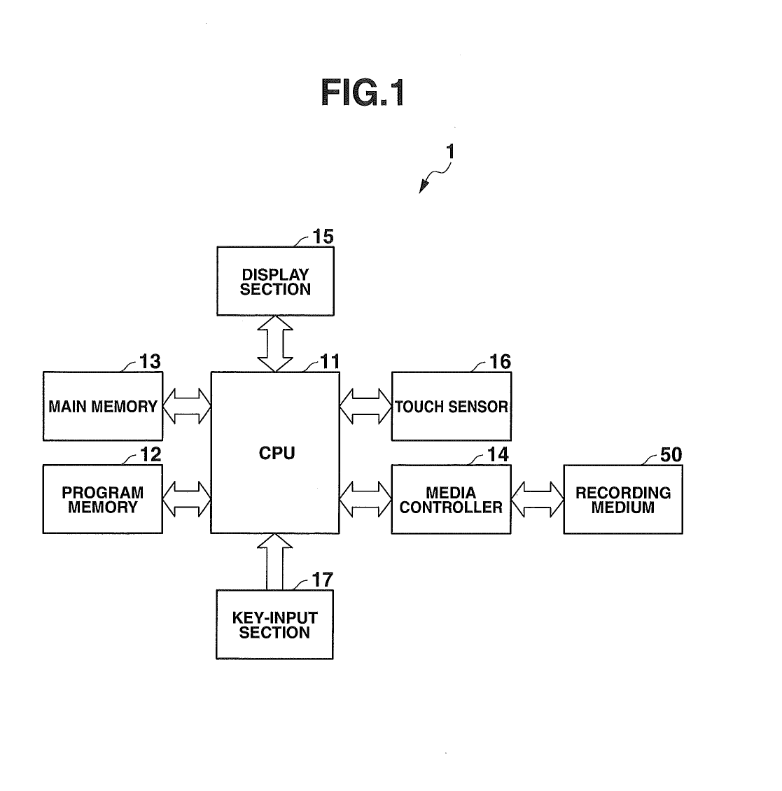

In the following, an embodiment of the present invention will be explained. FIG. 1 is a block diagram illustrating a display apparatus 1 of a first embodiment of the present invention.

The display apparatus 1 comprises a CPU (Central Processing Unit) 11 that performs overall control of the apparatus, a program memory 12, a main memory 13, a media controller 14, a display section 15, a touch sensor 16, and a key-input section 17.

The program memory 12 is, for example, a non-volatile recording medium comprising an built-in flash memory. The program memory 12 stores programs that are necessary for the CPU 11 to control the display apparatus 1, and stores various kinds of data. The various kinds of data will be explained in detail later.

The main memory 13 is, for example, a randomly accessible volatile recording medium comprising a DRAM (dynamic random-access memory), and is used as a work memory when the CPU 11 executes a program. In other words, the main memory 13 stores programs that the CPU 11 reads from the program memory 12, and stores various kinds of data that are generated during control.

The media controller 14 is an input/output interface that controls input and output of data between a recording medium 50 that is removably mounted in a memory-card slot that is provided in the main body (not illustrated in the figure) of the display apparatus 1 and the CPU 11.

The recording medium 50 is, for example, a non-volatile card type memory medium comprising a flash memory, and this recording medium 50 stores various kinds of data such as image data, document data and the like that is stored by a user.

Here, image data is image data that was taken and stored using a digital camera, for example, or in other words, is data of a still image file that complies to a standards such as Exif (Exchangeable Image File Format), and to which image information, such as the date and time the image was taken, has been added to the main image data that has been compressed by the JPEG (Joint Photographic Expert Group) method. Document data is data of a document and the like that has been created using so-called word-processing software for example.

The display section 15 is a display that has a screen that functions as a touch panel, and comprises a color liquid-crystal display panel with backlighting, and a drive circuit for driving that display panel.

The touch sensor 16 is, for example, a capacitance type of sensor that is integrally provided on the surface of the color liquid-crystal display panel of the display section 15, and this touch sensor 16 detects the operation of a user on the display screen and supplies that information to the CPU 11.

The key input section 17 comprises a power-supply key and other function buttons, and supplies operation information of a user operating the operation buttons to the CPU 11.

The programs that are stored in the program memory 12 include programs that cause the CPU 11 to execute a content display process or an added information display process that will be described later.

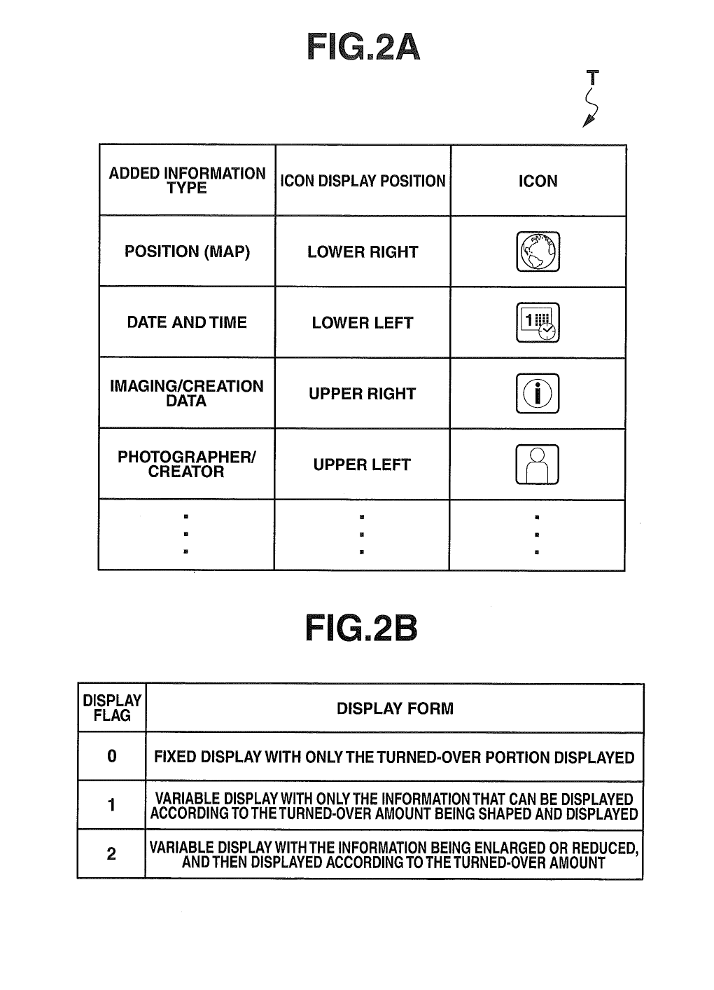

Moreover, the various kinds of data that are stored in the program memory 12 include a setting table T such as illustrated in FIG. 2A that is used by the CPU 11 in the added information display process, or a display flag such as illustrated in FIG. 2B.

The setting table T is a table that illustrates the type of added information, the display positions of icons on the screen of the display section 15, and the correspondence to the icons. The type of added information is the type of added content of added data that is added to image data or document data that is stored in the recording medium 50 and that is integrally stored with the image data or document data.

As types of added information there are various kinds of data such as position or map data, date and time data, imaging data or creation data, and photographer or creator data. The position or map data is, for example, the latitude, longitude, city name, or a map or flag expressing those. Imaging data or creation data is information about the image data such as Exif information and the like, or information about the created data such as the number of pages or paper size.

The display position of icons is the position on the screen of the display section 15 and is either lower right, lower left, upper right or upper left, or in other words, is one of the four corners of the screen.

Moreover, FIG. 2A illustrates a setting table T, and the icons illustrated in the figure are actually ID information for image data that is stored in the program member 12; for example, the data name. Each of the actual icons that are expressed by image data has a design that expresses the type of added information that corresponds to each.

On the other hand, display flag is information that is set by the CPU 11 during the added information display process for setting the display state of added information on the screen of the display section 15; the value being a value “0” to “2” that is set in advance, or that is changed by the user as necessary.

Here, the value “0” indicates a fixed display of added information, and is a display state in which only a virtually turned over portion is displayed; the value “1” indicates a variable display of added information, and is a display state in which only information (content) that can be displayed according to the amount that the display is virtually turned over is changed and displayed; and value “2” indicates a variable display of added information, and is a display state in which the information is enlarged or reduced according to the amount that the display is turned over so as to be able to be displayed. The display states that are indicated by each display flag value will be described in detail later.

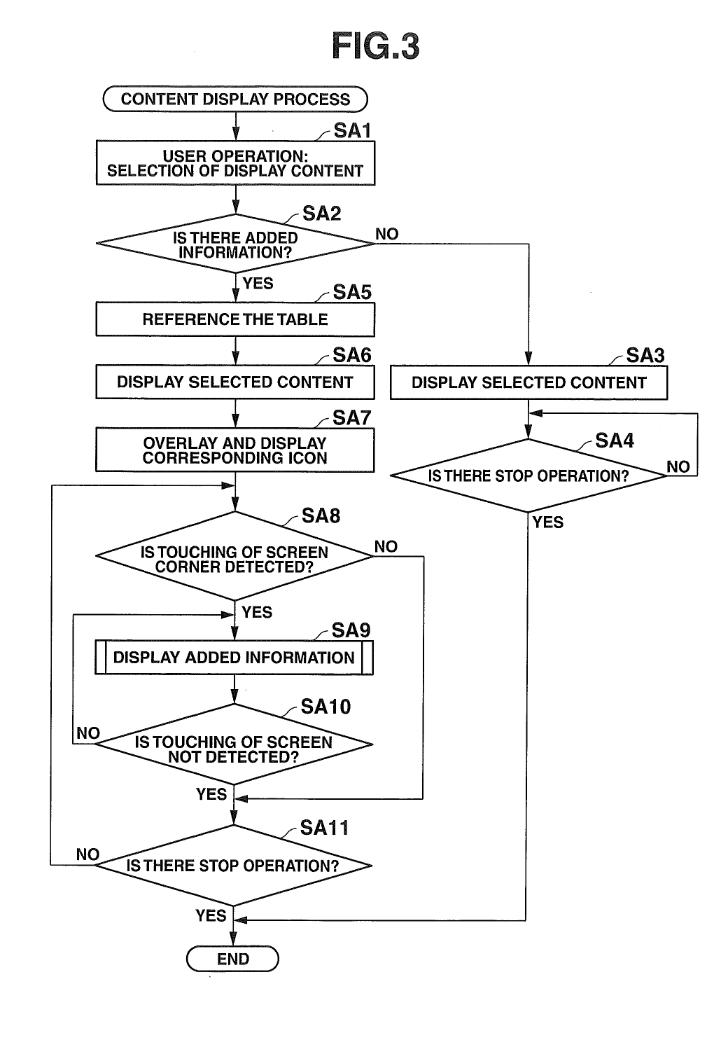

Next, the operation of the display apparatus 1 of the present invention that is constructed as described above will be explained. FIG. 3 is a flowchart indicating the content display process that is executed by the CPU 11 when the user displays image data or document data (hereafter, called content) that is stored by the recording medium 50.

As illustrated in FIG. 3, after the content to be displayed has been selected by the user by operating the touch panel or operation buttons, for example (step SA1), the CPU 11 checks whether or not there is added information for the selected content, or in other words, checks whether added information has been added to the image data or document data (step SA2).

Here, when there is no added information (step SA2: NO), the CPU 11 reads the data (image data, document data or the like) of the selected content, and has that data displayed on the display section 15 (step SA3). In this embodiment, the display state of content on the display section 15 is a full-screen display.

After that, the CPU 11 continues the display of content until there is stop operation by the user (step SA4: NO), and when there is stop operation (step SA4: YES), ends the content display process at that instant.

On the other hand, when there is added information for the content selected by the user (step SA2: YES), the CPU 11 first references the setting table T that is illustrated in FIG. 2A and checks the icons and display positions of the icons that correspond to the types (one or more) of information actually included in the added information (step SA5).

Next, the CPU 11 reads the data of the selected content, or in other words, reads the main data from the recording medium 50, and causes the display section 15 to display selected content (step SA6).

During this process, the CPU 11 expands and stores added data that is added to the content data in the main memory 13 in a state in which the added data is classified into the types of information content given in the setting table T.

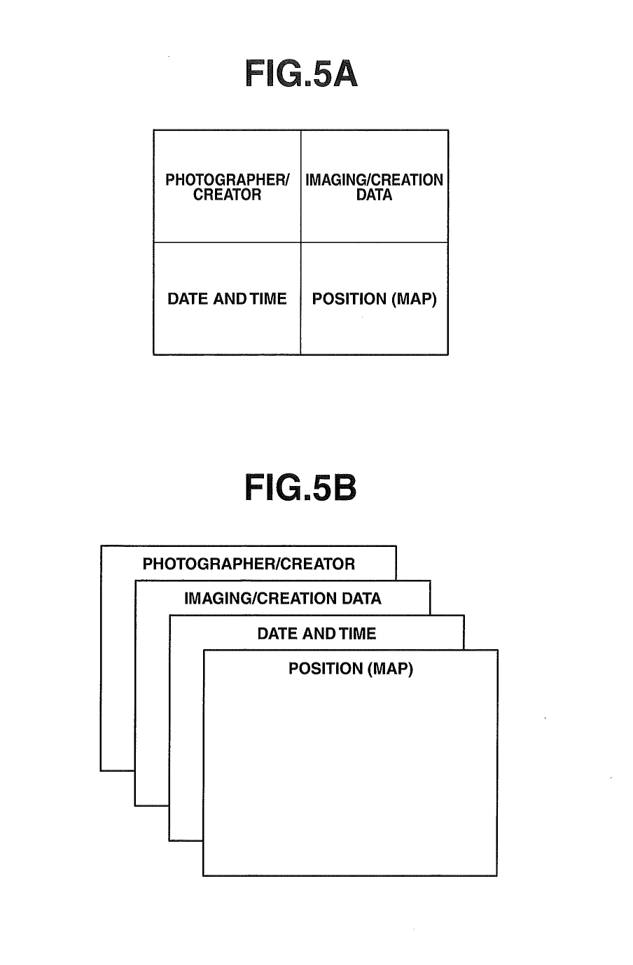

FIGS. 5A and 5B are drawings that conveniently illustrate examples of the stored state of added data in the main memory 13, where the types of information content that are included in the added data are the four types: position or map, data and time, imaging data or creation data, and photographer or creator.

In other words, FIG. 5A is an example of the case in which added data is classified into types of image content in a positional relationship that corresponds to the display position of the icons indicated in the setting table T and stored in the memory space for one screen. FIG. 5B is an example of the case in which added data is stored in plural layers (four in the figure) that are different from each other using the memory space for one screen for each type of information content.

Next, the CPU 11 overlays and displays icons corresponding to display positions over content at one or more display positions that were confirmed in the processing of step SA5 in the display area of displayed content (image, document or the like), or in other words, on the screen of the display section 15 (step SA7).

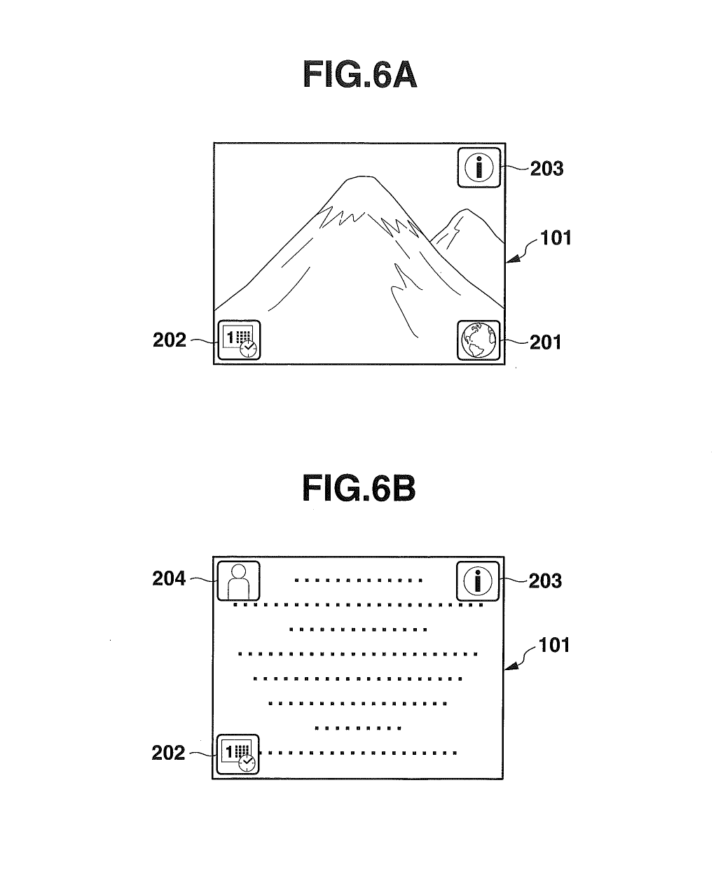

FIGS. 6A and 6B illustrate an example of a display by the display section 15 after the processing in step SA7, where in FIG. 6A, the selected content 101 is an image, and an icon 201 that expresses position or map is overlaid and displayed in the lower right corner of the screen, an icon 202 that expresses date and time is overlaid and displayed in the lower left corner of the screen, and an icon 203 that expresses imaging data or creation data is overlaid and displayed in the upper right corner of the screen.

Moreover, in FIG. 6B, the selected content 101 is a document, and an icon 202 that expresses date and time is overlaid and displayed in the lower left corner of the screen, an icon 203 that expresses imaging data or creation data is overlaid and displayed in the upper right corner of the screen, and an icon 204 that expresses the photographer or creator is overlaid and displayed in the upper left corner of the screen.

After that, the CPU 11 sequentially detects whether or not the user has touched any one of the corner portions of the screen where an icon is displayed (step SA8). Here, touching is a state in which the user has touched the screen with a finger, pen or the like.

When touching is not detected (step SA8: NO), the CPU 11 further checks whether or not there was a stop operation, and continues checking whether or not there has been a touch until there is a stop operation (step SA11: NO), and when there is a stop operation (step SA11: YES), ends the content display process at that instant.

On the other hand, when it is detected that one of the corner portions of the screen where an icon is displayed has been touched (step SA8: YES), the CPU 11 executes the added information display process.

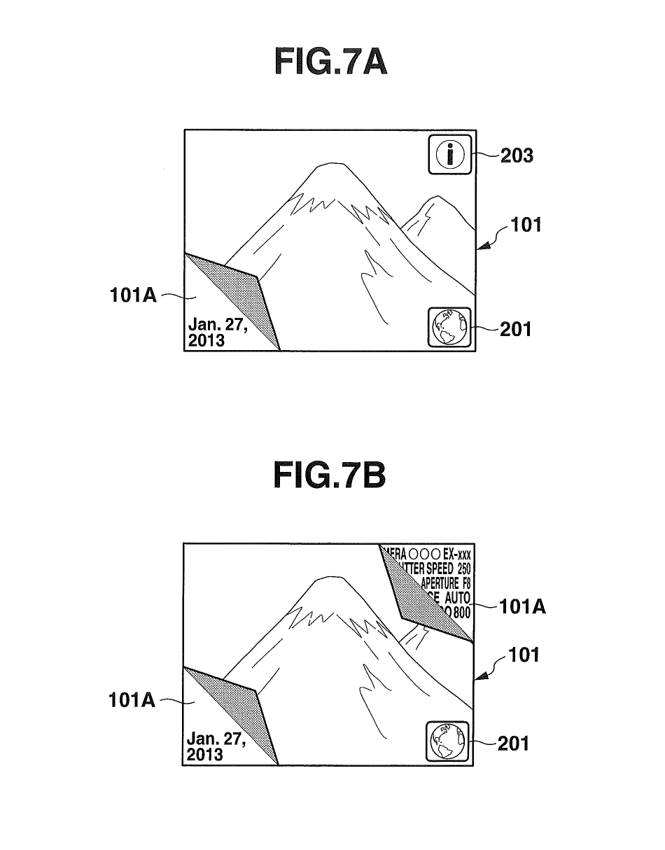

As illustrated in FIGS. 7A and 7B, the added information display process is a process that keeps substitution areas 101A in parts of the display area where content 101 is displayed (entire screen), and for the displayed content, substitutes and displays information content of the type that corresponds to the touched corner, this information content being added information that is added to the displayed content 101.

To explain this in more detail, during the added information display process, the CPU 11 presumes two-layer structure in which the display surface of the displayed content 101 is taken to be a virtual top layer (a thin layer), and the surface behind that surface is taken to be a virtual lower layer, and by expressing the displayed content 101 in a state in which a corner that is touched by the user is “turned over” toward the opposite corner, the area on the lower-layer side that corresponds to the turned-over portion is kept as a substitution area 101A. Then, the CPU 11 causes the information content of the corresponding type to be displayed in that substitution area 101A in a specified display state. The display state of the information content will be described in detail later.

After that, the CPU 11 repeats the added information display process until a touch state is no longer detected, or in other words, until the user's finger, pen or the like is removed from the screen (step SA10: NO), and when a touch state is no longer detected (step SA10: YES), the CPU 11 checks whether or not there is stop operation from the user (step SA11).

Here, when there is no stop operation (step SA11: NO), the CPU 11 returns to the processing of step SA8, and again detects whether or not a corner portion on the screen where an icon is displayed is touched, and repeats the processing described above. When there is a stop operation during this time (step SA11: YES), the CPU 11 ends the content display process at that instant. As a result, the CPU 11 ends the arbitrary content display process.

Next, as illustrated in FIGS. 6A and 6B, the added information display process (step SA9) described above that is executed by the CPU 11 with icons 201, 202, and 203 being overlaid and displayed in three corners of the content 101 will be explained.

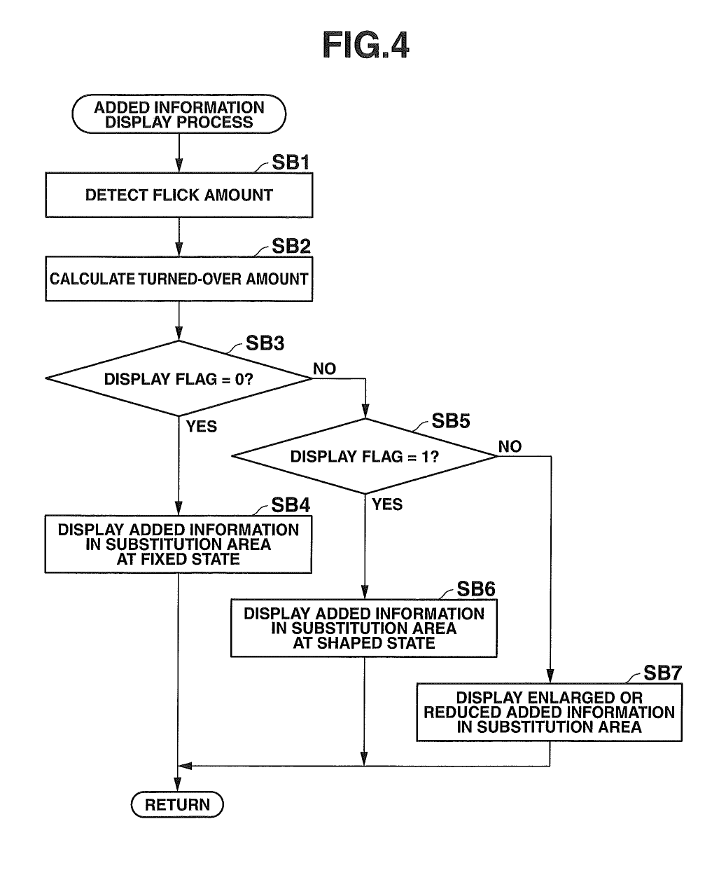

FIG. 4 is a flowchart that illustrates the added information display process by the CPU 11. As illustrated in FIG. 4, in the added information display process, the CPU 11 immediately detects flick amount by a finger after the screen of the display section 15 has been touched (step SB1).

This flick amount is the amount a finger moves on the screen during a specified amount of time (for example, 0.1 second), and the CPU 11 detects the touch position of a finger on the screen at every specified time, and detects the flick amount based on the current touch position and the touch position at the previous specified time.

The flick amount is a plus flick amount when going from the original touch position in a direction toward the corner that is opposite from the nearest corner, and conversely, the flick amount is a minus flick amount when going from the original touch position in a direction toward the nearest corner.

Next, the CPU 11 calculates turned-over amount that corresponds to the detected flick amount (step SB2). Here, the turned-over amount is an accumulated value of the flick amount described above while the added information display process is continuously performed.

After that, when the value of the display flag described above that indicates the display state of added information is “0” (step SB3: YES), the CPU 11 displays added information of the type that corresponds to that area at fixed state in the aforementioned substitution area 101A (step SB4).

In other words, the CPU 11, as described above, expresses the turned-over amount that was acquired in the processing of step SB2 in a “turned-over” state going in the direction opposite from the portion of the corner where the user touched the displayed content 101, keeps the area corresponding to the turned-over portion as a substitution area 101A, and displays added information in that area at fixed state.

Here, displayed at fixed state is the displaying of added information in a state in which the display position on the screen of the display section 15 and the display shape and display size are fixed to a predetermined display position, display shape and display size. In other words, at the start of processing, the CPU 11 displays only part of the added information that is fixed in the substitution area 101A that corresponds to the portion of the content 101 that is turned over in that position.

The CPU 11 then ends the added information display process and returns to the processing in FIG. 3 and repeatedly executes the added information display process until the user's finger is separated from the screen, or in other words, while the user moves a finger over the screen.

In doing so, by the user moving a finger over the screen in a direction toward the center of the screen a plus flick amount, the size of the substitution area 101A can be gradually increased, and an amount of added information can be displayed that corresponds to the area of the substitution area 101A.

FIG. 7A is a drawing that illustrates a state in which, when content 101 is a photographed image, all of the added information of a type that corresponds to that position (date and time) is displayed in the substitution area 101A by the user touching the lower left corner of the screen where the icon expressing date and time is displayed with a finger, and moving that finger as is in a direction toward the center of the screen.

FIG. 7B is a drawing illustrating a state after that in which part of the added information (camera model name, shutter speed, and the like) of the type corresponding to the position is displayed in another substitution area 101A by the user touching the upper right corner of the screen where the icon 203 that expresses imaging data or creation data is displayed with a finger, and moving that finger as is in a direction toward the center of the screen.

Conversely, in a state such as illustrated in FIG. 7B, for example, with the user's finger on the screen as is, it possible to gradually reduce the size of the substitution area 101A by the user moving the finger a minus flick amount in a direction toward the upper right part of the screen.

On the other hand, differing from the case above, after the turned-over amount has been calculated in the processing of step SB2, when the value of the display flag was “1” (step SB3: NO, step SB5: YES), the CPU 11 displays added information of the type corresponding to the substitution area 101A described above, at shaped state in that area (step SB6).

In other words, the CPU 11 expresses the displayed content 101 described above in a “turned-over” state by the turned-over amount that was acquired in the processing of step SB2, keeps an area that corresponds to the turned-over portion as the substitution area 101A, and displays added information at shaped state in that area.

Here, display at shaped state is displaying added information in a state in which only the display size on the screen of the display section 15 is fixed at a predetermined display size, and in order to display the maximum amount of added information in the substitution area 101A, the placement form of the added information is shaped according to the size of the substitution area 101A and displayed.

Then, the CPU 11 ends the added information display process and returns to the processing in FIG. 3, and repeatedly executes the added information display process until the user's finger is removed from the screen, or in other words, while the user moves a finger over the screen.

Therefore, even in the case where the display flag value is “1”, it is possible to gradually increase the size of the substitution area 101A by the user moving a finger over the screen a plus flick amount in a direction toward the center of the screen, and can display an amount of added information that corresponds to the size of the substitution area 101A.

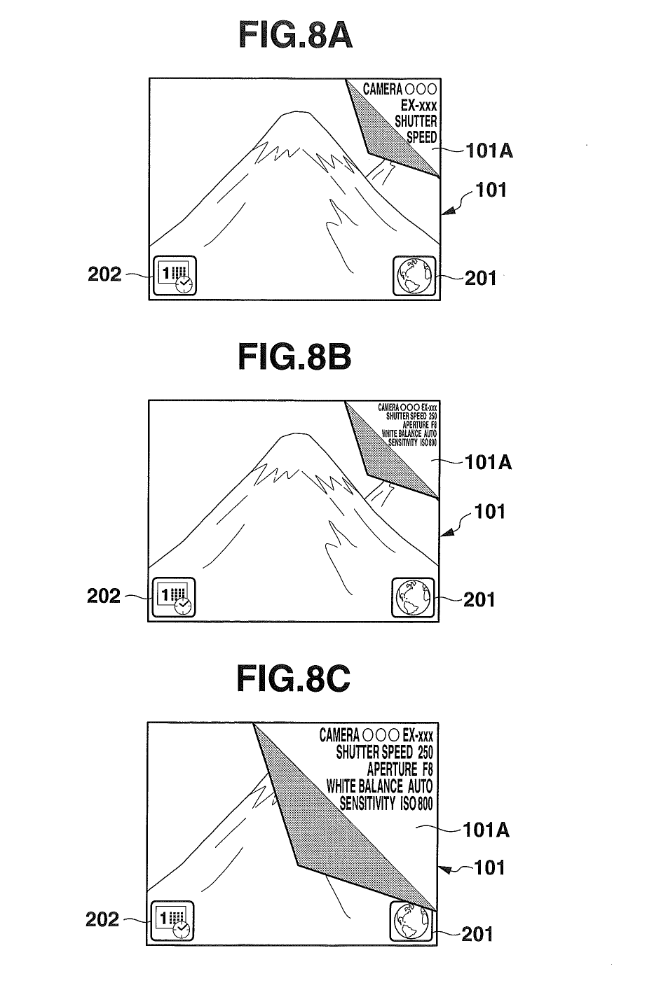

FIG. 8A is a drawing illustrating a state in which, when the content 101 is a photographed image, by the user touching the lower left corner of the screen where the icon 203 expressing imaging data or creation data is displayed with a finger, and moving that finger as is over the screen in a direction toward the center of the screen, added information of a type that corresponds to the substitution area 101A (image data) is changed according to the size and shape of the substitution area 101A so that as much information as possible can be displayed in that area.

Even in the state illustrated in FIG. 8A, the user can gradually reduce the size of the substitution area 101A by moving the finger on the screen a minus flick amount in a direction toward the upper right of the screen.

Furthermore, differing from the case above, when the display flag value was “2” (step SB5: NO) after the turned-over amount was calculated by the processing in step SB2, the CPU 11 enlarges or reduces added information of a type corresponding to the substitution area 101A described above, and displays added information in that area (step SB7).

In other words, the CPU 11 expresses the displayed content 101 described above in a “turned-over” state by the turned-over amount that was acquired in the processing of step SB2, keeps an area that corresponds to the turned-over portion as the substitution area 101A, and enlarges or reduces the added information and displays that information in that area.

Here, an enlarged or reduced display is changing the added information to the maximum size that can be arranged in the substitution area 101A.

The CPU 11 then ends the added information display process and returns to FIG. 3, and repeatedly executes the added information display process until the user's finger is removed from the screen, or in other words, while the user moves a finger over the screen.

Therefore, when the display flag value is “2”, the user can gradually increase the size of the substitution area 101A by moving a finger over the screen a plus flick amount in a direction toward the center of the screen, and can display all of the added information in the substitution area 101A regardless of the size of the substitution area 101A.

FIG. 8B is a drawing that illustrates a state in which, when the content 101 is a photographed image, the entire added information of a type corresponding to the substitution area 101A (camera model name, shutter speed, and the like) is displayed in that area by reducing the display size to be smaller than the predetermined display size illustrated in FIG. 7B by the user touching with a finger the upper right corner of the screen where the icon 203 that expresses imaging data or creation data is displayed, and then moving that finger as is toward the center of the screen.

FIG. 8C is a drawing illustrating a state in which, from the state illustrated in FIG. 8B, the entire added information is displayed in an enlarged state larger than the predetermined display size illustrated in FIG. 7B by the user continuing to move the finger toward the center of the screen and enlarging the size of the substitution area 101A.

Even in the state illustrated in FIG. 8C, the user can return the display state to the state illustrated in FIG. 8B by moving the finger over the screen a minus flick amount in a direction toward the upper right of the screen to gradually reduce the size of the substitution area 101A.

In this embodiment as explained above, a user can change the size of the substitution area 101A in real-time as necessary while added information that is added to arbitrary content that is stored in a recording medium 50 is displayed on the screen together with that content. Therefore, it is possible to increase the degree of freedom when displaying added information that is added to information content of main data such as image data or document data while that main data is displayed.

Particularly, as illustrated in FIGS. 7A and 7B, when added information is displayed in a fixed state, the display of added information is fixed, including the hidden portion, and only part of the added information is displayed according to the size of the substitution area 101A. In other words, the added information is always displayed in a fixed form. Therefore, it is possible to easily know what kind of information is correlated with the displayed content.

Moreover, as illustrated in FIG. 8A, when added information is displayed in a shaped state, as the size of the substitution area 101A is gradually increased, individual information content that is included in added information of the same type is arranged and displayed in a set order. Therefore, a group of information content that is included in added information of the same type can be displayed in order from information having the highest priority.

Furthermore, as illustrated in FIGS. 8B and 8C, when the added information is enlarged or reduced and displayed, it is possible to always display the entire group of information content that is included in added information of the same type. In other words, it is possible to always know all of the information.

Regardless of the arrangement form of added information in the substitution area 101A described above, in this embodiment, a substitution area 101A is kept in one of the four corners of the content display area (the display screen in this embodiment). Therefore, even when added information is displayed at the same time, generally there is no worry that an important part of the content that is in a position or area near the center of the screen will be hidden, and so is easy to use.

Moreover, by overlaying and displaying icons 201, 202, 203 on displayed content in order to indicate that added information exists, it is possible for the user to easily distinguish the added information. Furthermore, each icon has a design that expresses the type of corresponding added information, so that it is easy to acquire and distinguish the type of added information that can be displayed.

When displaying added information, the corners of the content are expressed in a virtual “turned-over” state, and the area that corresponds to the turned-over portion is kept as a substitution area 101A. In other words, added information is displayed in the turned-over area. Therefore, a visual effect is obtained that is different than in the conventional case, so with that visual effect, not only is it possible to simply provide added information content, but in the case where the displayed content is an image, it is possible to provide the user with entertainment.

Here, in the explanation above, the case was explained in which immediately after a user displays content 101 such as image data, document data and the like that is stored in a recording medium 50, added information that is added to that content is displayed. However, the timing when added information is displayed by applying the present invention can be at an arbitrary time, or when the content 101 is a document for example, can be displayed when editing that document.

Moreover, in this embodiment, the case was explained in which the value of a display flag that determines the display form of the added information is a predetermined value, or is a value that is changed as necessary by the user, and is set beforehand unrelated to the content to be displayed. However, the value of the display flag above can also be pre-embedded in the added information, for example, or can be set by the user before performing the display operation for displaying added information (flick operation on the screen).

In this embodiment, the case was explained in which a substitution area 101A that displays added information that is added to content 101 is kept in one or more of the corners of the content 101. However, when implementing the present invention, instead of the four corners or in addition to the four corners of the content 101, it is also possible to keep substitution areas 101A on the four sides of the content 101.

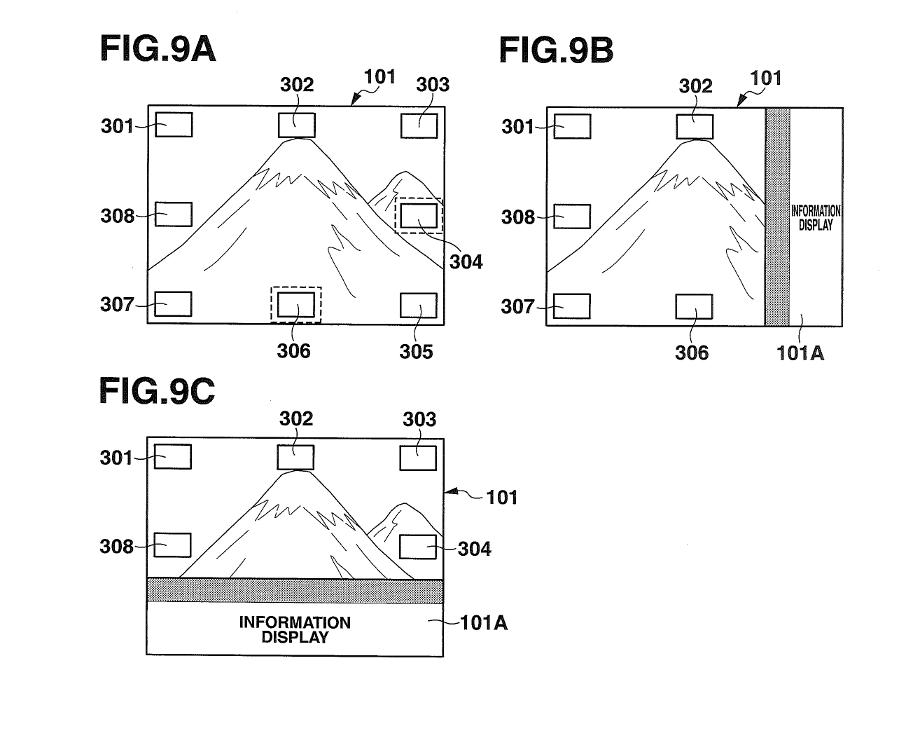

FIG. 9A is a drawing illustrating an example in that case, and is an example in which substitution areas 101A are kept in all four corners and on all four sides of the content 101. In FIG. 9A, the content 101 is a photographed image, and by including information content about the type in the added information, icons 301 to 308 (the design has been omitted) are overlaid and displayed in all four corners and all four sides of the content 101.

In this case, for example, when icon 304 in the center of the right side of content 101 or the surrounding area is flicked in a direction toward the left side, a substitution area 101A is kept in a portion on the right side of the content 101 as illustrated in FIG. 9B, and added information of the corresponding type can be displayed. Moreover, the expression of content 101 at that time can be expressed in a “turned-over” state in which the edge portion on the right side is turned over toward the left side an amount that corresponds to the flick amount.

Similarly, when icon 306 in the center of the bottom side of content 101 or the surrounding area is flicked in a direction toward the top side, a substitution area 101A is kept in a variable portion of the content 101 as illustrated in FIG. 9C, and added information of the corresponding type can be displayed. Moreover, the expression of content 101 at that time can be expressed in a “turned-over” state in which the edge portion on the bottom side is turned over toward the top side an amount that corresponds to the flick amount.

Also, in this embodiment, the case was explained in which when a substitution area that displays added information is kept on the screen, as described above, a corner or side portion of the content is expressed in a “turned-over” state. However, the embodiment is not limited to this, and it is also possible to keep a substitution area by simply making part of the displayed content disappear.

Moreover, in this embodiment, the case was explained in which added information that is added to content is displayed in a substitution area, or in other words, information content of data that is added to main data is displayed in a substitution area. However, as long as the information that is displayed in a substitution area is related data that is correlated with image data or document data that is stored in a recording medium 50, for example, the information can be information content of data that is stored separately from the image data or document data. Furthermore, in the case of a display apparatus that comprises a communication function, the information could also be acquired from another external apparatus using the communication function.

While the present invention has been described with reference to the preferred embodiments, it is intended that the invention be not limited by any of the details of the description therein, but includes all the embodiments which fall within the scope of the appended claims.

What is claimed is:

1. A display apparatus comprising:
a display section that displays main data and related data that is related to the main data;
a display control section that, when main data is displayed on a screen of the display section, keeps a substitution area, in which other display content is substituted for the displayed content, in part of a display area displaying the main data, and displays the related data substituted for the main data in the substitution area; and
an area control section that changes the position or size of the substitution area kept by the display control section in response to an instruction from a user.

2. The display apparatus according to claim 1, wherein
the display control section controls the display state of the related data on the screen of the display section according to the position or size of the substitution area.

3. The display apparatus according to claim 2, wherein
control of the display state of related data by the display control section is control that, when the display position, display form and display size of the related data on the screen of the display section are in a fixed state, changes only the information amount of the related data in the substitution area according to the size of the substitution area; or is control that changes only the information content of the related data in the substitution area according to the position of the substitution area.

4. The display apparatus according to claim 2, wherein
control of the display state of related data by the display control section is control that, when the display size of the related data is fixed as is, the form in which information content of the related data is arranged is changed according to the size of the substitution area so that a maximum amount of the information content of the related data is displayed in the substitution area.

5. The display apparatus according to claim 2, wherein
control of the display state of related data by the display control section is control that changes the display size of the related data according to the size of the substitution area to a maximum size that can be arranged in the substitution area.

6. The display apparatus according to claim 1, wherein
the display control section keeps the substitution area in at least one of the four corners of the display area of the main data.

7. The display apparatus according to claim 6, wherein
the display control section places an index that indicates the existence of the related data in a position in the display area of the main data that corresponds to the substitution area.

8. The display apparatus according to claim 7, wherein
the index, in addition to the existence of the related data, indicates the type of information content of the related data.

9. The display apparatus according to claim 6, wherein
the display control section virtually takes the screen of the display section to have a multi-layer structure in which the main data is an upper layer of the display surface, and the related data is a lower layer of the display surface, and keeps the substitution area by virtually expressing a corner portion of the upper layer on the screen of the display section in a turned-over state; and
the area control section increases or decreases the size of the substitution area in response to an instruction from a user by controlling the virtual amount that the corner portion is turned over in response to an instruction from the user.

10. The display apparatus according to claim 1, wherein
the related data is data that is added to the main data.

11. A display method comprising:
a step that, when main data is displayed on a screen of the display section that displays main data and related data that is related to the main data, keeps a substitution area, in which other display content is substituted for the displayed content, in part of a display area displaying the main data, and displays the related data substituted for the main data in the substitution area; and
a step that changes the position or size of the substitution area in response to an instruction from a user.

12. A non-transitory memory medium that can be read by a computer and that stores programs for causing a computer to realize:
a display control function that, when main data is displayed on a screen of a display section that displays main data and related data that is related to the main data, keeps a substitution area, in which other display content is substituted for the displayed content, in part of a display area displaying the main data, and displays the related data substituted for the main data in the substitution area; and
an area control function that changes the position or size of the substitution area kept by the display control function in response to an instruction from a user.
